(19) United States
(12) Patent Application Publication
(10) Pub. No.: US 2016/0100632 A1
(43) Pub. Date: Apr. 14, 2016

(54) TEMPERATURE CONTROL OF ELECTRONIC VAPORIZERS

(71) Applicants: Michael Debono, Dallas, TX (US); Brian Chadwick, Irving, TX (US)

(72) Inventors: Michael Debono, Dallas, TX (US); Brian Chadwick, Irving, TX (US)

(21) Appl. No.: 14/931,288

(22) Filed: Nov. 3, 2015

Related U.S. Application Data
(63) Continuation-in-part of application No. 14/881,963, filed on Oct. 13, 2015.
(60) Provisional application No. 62/062,861, filed on Oct. 11, 2014.
(60) Provisional application No. 62/074,180, filed on Nov. 3, 2014.
(60) Provisional application No. 62/074,737, filed on Nov. 4, 2014.

(51) Int. Cl. A24F 47/00; H05B 1/02; H05B 3/42

(52) U.S. Cl. CPC A24F 47/008; H05B 3/42; H05B 1/0244

(57) ABSTRACT

In one aspect of the disclosure, a temperature control unit (TCU) is described for use with a personal vaporizer including a tank that receives a fluid. The TCU includes an inner surface including a first metallic material, an outer surface including a second, dissimilar metallic material, and a power source in electrical communication with the inner and outer surfaces such that current is flowable from the power source to the inner and outer surfaces, whereby one of the inner and outer surfaces increases in temperature, and the other of the inner and outer surfaces decreases in temperature. In another aspect of the disclosure, a refillable tank is described for use with a personal vaporizer. The tank includes a body that is configured and dimensioned to retain a fluid, and a TCU that is connected to the body to facilitate heating and/or cooling of the body and/or the fluid.

### CROSS-REFERENCE TO RELATED APPLICATIONS

This application is a continuation-in-part application of U.S. patent application Ser. No. 14/881,963, filed on Oct. 13, 2015, which claims the benefit of, and priority to, U.S. Provisional Patent Application Ser. No. 62/062,861, filed on Oct. 11, 2014, the entire contents of which are incorporated herein by reference. This application also claims the benefit of, and priority to, U.S. Provisional Patent Application Ser. No. 62/074,180, filed on Nov. 3, 2014, and U.S. Provisional Patent Application Ser. No. 62/074,737, filed on Nov. 4, 2014, the entire contents of which are incorporated herein by reference.

### TECHNICAL FIELD

The present disclosure relates generally to personal vaporizers, e.g., electronic cigarettes, and more specifically, to devices, systems, and methods for controlling the temperature and pressure of personal vaporizers.

### BACKGROUND

Personal vaporizers have become a popular alternative to conventional cigarettes. A typical personal vaporizer, identified by the reference character 100 in FIG. 1, includes a battery 1, a power button 2, a refillable tank 3 that is configured and dimensioned to receive a fluid, a wick 4 that is at least partially positioned within the tank 3, a mouthpiece 5, toggles (switches) 6 to control operation of the vaporizer 100, a display 7, e.g., an LED display, a microchip 8, and an atomizer 9. In general, the tank 3 is formed from any material suitable for retaining the fluid such as, for example, plastic, glass, Pyrex, ceramic, or metallic materials.

Often times one or more components of the vaporizer 100 will be separable or disassemblable from the remainder of the unit to permit cleaning, maintenance or repair, replacement, exchange, etc. For example, the battery 1 is often removable in order to permit recharging or replacement, and is the tank 3 in order to permit the user to refill the tank with additional fluid, or replace the tank altogether.

Known vaporizers, however, have several drawbacks. For example, variations in temperature and/or pressure can result in the leakage of fluid from the vaporizer, as well as changes in the viscosity of the fluid, which may negatively impact the efficiency, efficacy, and/or overall use of the vaporizer. Additionally, with respect to electronic cigarettes in particular, it has been found that variations in temperature and/or pressure can also impact the characteristics of the vapor formed by the electronic cigarettes, e.g., the taste of the vapor.

The present disclosure addresses these concerns by providing various devices, systems, and methods for controlling the temperature and pressure in personal vaporizers.

### SUMMARY

In accordance with one aspect of the present disclosure, a temperature control unit is disclosed for use with a personal vaporizer including a tank that is configured and dimensioned to retain a fluid. The temperature control unit includes an inner surface including a first metallic material, an outer surface including a second, dissimilar metallic material, and a power source in electrical communication with the inner and outer surfaces such that current is flowable from the power source to the inner and outer surfaces, whereby one of the inner and outer surfaces experiences an increase in temperature, and the other of the inner and outer surfaces experiences a decrease in temperature.

In certain embodiments, the temperature control unit may further include a first thermocouple connected to the inner surface to measure the temperature of the inner surface, and a second thermocouple connected to the outer surface to measure the temperature of the outer surface.

In certain embodiments, the temperature control unit may further include a controller in electrical communication with the first and second thermocouples such that temperature data collected by the first and second thermocouples is communicated to the controller.

In certain embodiments, the controller may be in electrical communication with the power source such that the flow of current from the power source to the inner surface and the outer surface can be interrupted by the controller.

In certain embodiments, the controller may be programmable to interrupt the flow of current from the power source to the inner surface and the outer surface upon the measurement of a predetermined temperature by one or more of the first and second thermocouples.

In certain embodiments, the temperature control unit may further include a toggle in communication with the power source to initiate and suspend the flow of current from the power source to the first surface and the second surface.

In certain embodiments, the temperature control unit may further include at least one toggle in communication with the power source to vary current flow from the power source to the first surface and the second surface to thereby control the temperature of the first and second surfaces.

The inner surface of the temperature control unit defines a first surface area, and the outer surface defines a second surface area. In certain embodiments, the first surface area and the second surface area may be approximately equal. Alternatively, the first surface area and the second surface area may be unequal.

In another aspect of the present disclosure, a refillable tank is disclosed for use with a personal vaporizer. The tank includes a body that is configured and dimensioned to retain a fluid therein, and a temperature control unit that is connected to the body of the tank to facilitate heating and/or cooling of the body of the tank and/or the fluid retained therein.

In certain embodiments, the temperature control unit may comprise an inner surface including a first metallic material, and an outer surface including a second, dissimilar metallic material.

In certain embodiments, the refillable tank may further include a first thermocouple connected to the inner surface to measure the temperature of the inner surface, and a second thermocouple connected to the outer surface to measure the temperature of the outer surface.

In certain embodiments, the refillable tank may further include a controller in electrical communication with the first and second thermocouples such that temperature data collected by the first and second thermocouples is communicated to the controller.

In certain embodiments, the refillable tank may further include a power source in electrical communication with the inner and outer surfaces of the temperature control unit such that current is flowable from the power source to the inner and outer surfaces, whereby one of the inner and outer surfaces experiences an increase in temperature, and the other of the inner and outer surfaces experiences a decrease in temperature.

In certain embodiments, the power source may be integral to the temperature control unit.

In certain embodiments, the controller may be in electrical communication with the power source such that the flow of current from the power source to the inner surface and the outer surface can be interrupted by the controller.

In certain embodiments, the controller may be programmable to interrupt the flow of current from the power source to the inner surface and the outer surface upon the measurement of a predetermined temperature by one or more of the first and second thermocouples.

The inner surface of the temperature control unit defines a first surface area, and the outer surface defines a second surface area. In certain embodiments of the refillable tank, the first surface area and the second surface area may be approximately equal. Alternatively, the first surface area and the second surface area may be unequal.

In another aspect of the disclosure, a temperature control unit configured and dimensioned for use with a personal vaporizer is disclosed that includes a body portion, and a power source.

The body portion defines an internal chamber that is configured and dimensioned to receive at least a portion of the personal vaporizer. The body portion has an inner surface that includes a first metallic material, and an outer surface that includes a second, dissimilar metallic material,

The power source is in electrical communication with the inner and outer surfaces of the body portion such that current is flowable from the power source to the inner and outer surfaces such that one of the inner and outer surfaces experiences an increase in temperature, and the other of the inner and outer surfaces experiences a decrease in temperature.

In certain embodiments, the temperature control unit may further include at least one thermocouple that is in communication with one of the inner and outer surfaces to measure the temperature thereof. For example, in one particular embodiment, the temperature control unit may include a first thermocouple in communication with the inner surface to measure the temperature of the inner surface, and a second thermocouple in communication with the outer surface to measure the temperature of the outer surface.

In certain embodiments, the temperature control unit may further include a controller that is in electrical communication with the at least one thermocouple such that temperature data collected by the at least one thermocouple is communicated to the controller.

In certain embodiments, the controller may be in electrical communication with the power source such that the flow of current from the power source to the inner surface and the outer surface can be interrupted by the controller.

In certain embodiments, the controller may be programmable to interrupt the flow of current from the power source to the inner surface and the outer surface upon the measurement of a predetermined temperature by the at least one thermocouple.

In certain embodiments, the temperature control unit may further include a toggle that is in communication with the power source to suspend and resume the flow of current from the power source to the inner surface and the outer surface.

In certain embodiments, the temperature control unit may further include at least one toggle that is in communication with the power source to vary current flow from the power source to the inner surface and/or the outer surface to thereby control the temperature of the inner surface and/or the outer surface.

The inner surface defines a first surface area and the outer surface defines a second surface area. In certain embodiments, the first and second surface areas may be either approximately equal, or unequal.

In certain embodiments, the temperature control unit may further include a cover that is movable between open and closed positions.

In certain embodiments, the temperature control unit may further include an insulative member that is positioned at least partially about the body portion.

In another aspect of the present disclosure, a temperature control unit configured and dimensioned for use with a personal vaporizer is disclosed that includes a body portion defining an internal chamber that is configured and dimensioned to receive at least a portion of the personal vaporizer. The body portion includes inner and outer walls defining a cavity therebetween that is configured, dimensioned, and adapted to retain a temperature control medium capable of being heated and cooled.

In certain embodiments, the temperature control unit may further include the temperature control medium in the form of a thermal gel.

In certain embodiments, the body portion may include, e.g., be formed from, a thermoconductive material to facilitate thermal energy transfer between the body portion and the temperature control medium.

In certain embodiments, the body portion may be formed entirely of non-metallic materials.

In certain embodiments, the temperature control unit may further include a cover that is movable between open and closed positions.

In certain embodiments, the body portion may include a port that is configured and dimensioned to facilitate filling of the cavity with the temperature control medium.

In certain embodiments, the temperature control unit may further include an insulative member that is positioned at least partially about the body portion.

In another aspect of the present disclosure, a temperature control unit configured and dimensioned for use with a personal vaporizer is disclosed that includes a body portion, and a bladder that is positioned within the body portion.

The bladder defines a receiving area that is configured and dimensioned to receive at least a portion of the personal vaporizer, and is configured, dimensioned, and adapted to retain a temperature control medium capable of being heated and cooled.

### BRIEF DESCRIPTION OF THE FIGURES

Various embodiments of the present disclosure are described herein with reference to the figures, wherein:

FIG. 1 is a side view of an exemplary prior art personal vaporizer;

FIG. 2 is a side view illustrating the personal vaporizer shown in FIG. 1 in conjunction with one embodiment of a temperature control unit (TCU) according to the principles of the present disclosure;

FIG. 3 is an enlarged view of the TCU shown in FIG. 2;

FIG. 4 is a longitudinal cross-sectional view of a tank for use with a personal vaporizer that includes the TCU shown in FIGS. 2 and 3;

FIG. 5 is a transverse cross-sectional view of an alternate embodiment of the tank and the TCU shown in FIG. 4;

FIG. 6 is a side view of a personal vaporizer according to the principles of the present disclosure including an integral TCU;

FIG. 7 is a side view illustrating the personal vaporizer shown in FIG. 1 in conjunction with one embodiment of a temperature control unit (TCU) according to the principles of the present disclosure;

FIG. 8 is a side view illustrating the personal vaporizer shown in FIG. 1 in conjunction with an alternate embodiment of the TCU shown in FIG. 7 including a heat sink;

FIG. 9 is a side view illustrating the personal vaporizer shown in FIG. 1 in conjunction with another embodiment of a temperature control unit (TCU) according to the principles of the present disclosure;

FIG. 9A is a side view illustrating the personal vaporizer shown in FIG. 1 in conjunction with an alternate embodiment of the TCU shown in FIG. 9 including an insulative member;

FIG. 9B is a side view illustrating the personal vaporizer shown in FIG. 1 in conjunction with another embodiment of the TCU shown in FIG. 9 including an inner liner;

FIG. 10A is a side view illustrating the personal vaporizer shown in FIG. 1 in conjunction with another embodiment of the TCU shown in FIG. 9 including a bladder that retains a temperature control medium;

FIG. 10B is a transverse, cross-sectional view of the TCU shown in FIG. 10A;

FIG. 11 is a side view illustrating the personal vaporizer shown in FIG. 1 in conjunction with another embodiment of a temperature control unit (TCU) according to the principles of the present disclosure; and

FIG. 12 is a side view illustrating the personal vaporizer shown in FIG. 1 in conjunction with another embodiment of a temperature control unit (TCU) according to the principles of the present disclosure.

### DETAILED DESCRIPTION

Various embodiments of the present disclosure will now be described in detail with reference to the figures, wherein like references numerals identify similar or identical elements. In the figures, and in the following description, the term “personal vaporizer” should be understood to encompass electronic cigarettes, nicotine delivery systems, and the like.

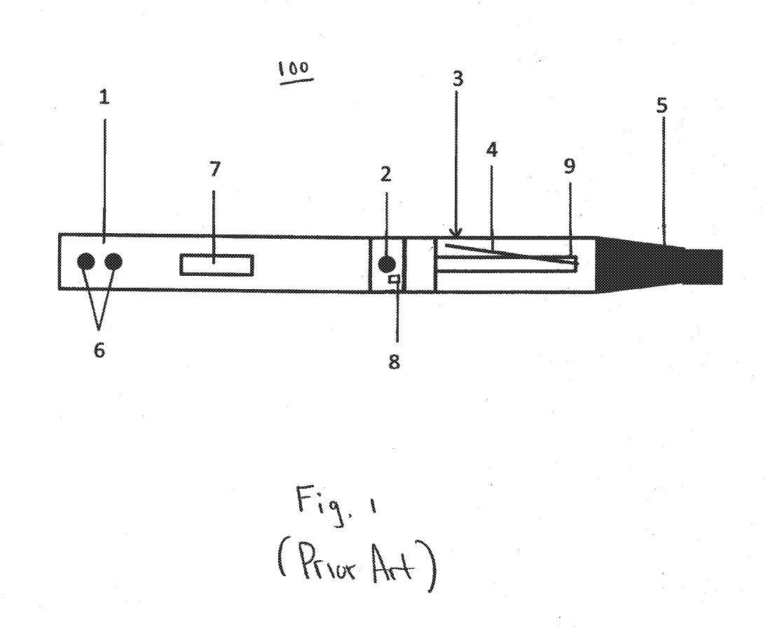

FIG. 2 illustrates one embodiment of a temperature control unit (TCU) 10, shown in conjunction with the vaporizer 100 (FIG. 1), which is configured, dimensioned, and adapted to provide the user with a measure of control over the temperature of the vaporizer 100 e.g., the tank 3 and/or the fluid within the tank 3. In the specific embodiment illustrated embodiment in FIG. 2, the TCU 10 is configured and dimensioned for positioning about the tank 3. To facilitate positioning about the tank 3, it is envisioned that the TCU 10 may include one or more expandable/contractible portions, e.g., one or more elastic, stretchable, or otherwise deflectable members. Additionally, or alternatively, the TCU 10 may include an over clamp design such that the TCU 10 may be “opened” for positioning about the tank 3, and thereafter “closed” and locked in place in secured contact with the tank 3. It is further envisioned that the TCU 10 may be configured and dimensioned in correspondence with a particular tank design, e.g., a tank 3 that is manufactured or distributed by a particular commercial source, such that the TCU 10 defines an inner contour corresponding to an outer contour defined by the tank 3 such that the TCU 10 receives the tank 3 in mating engagement.

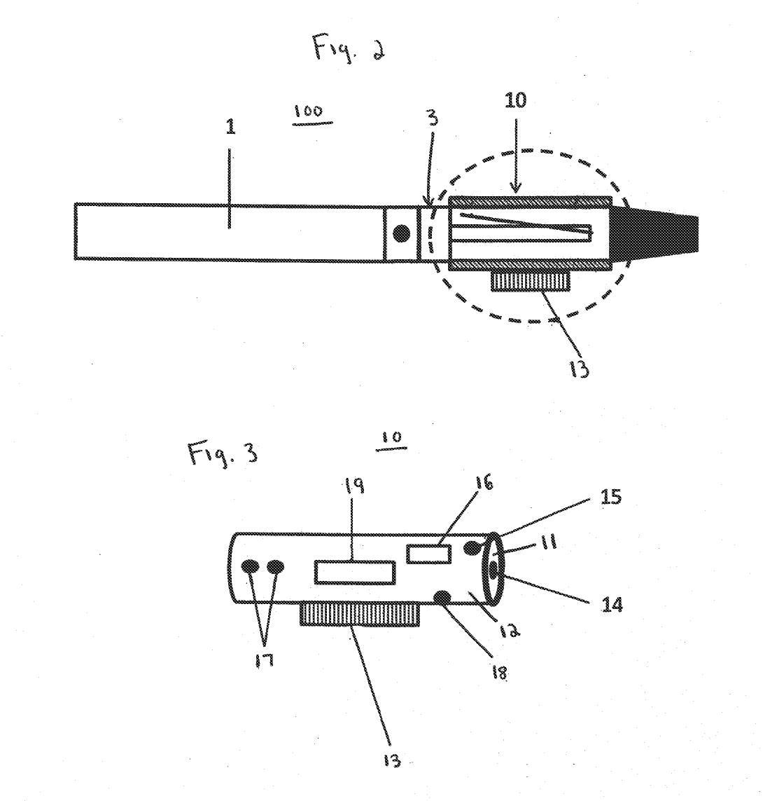

As seen in FIGS. 2 and 3, the TCU 10 includes an inner surface 11, an opposing outer surface 12, an integral, dedicated power source 13, e.g., a battery, in electrical communication with the respective inner and outer surfaces 11, 12, thermocouples 14, 15, a controller 16, e.g., a microchip including a processor, one or more toggles (switches) 17, e.g., a power switch/button 18, and a display 19, e.g., an LED display.

The inner surface 11 of the TCU 10 includes, e.g., is at least partially formed from, a first metallic material, such as copper, and is positioned in contact with the tank 3, e.g. an external surface of the tank 3. The outer surface 12 of the TCU 10 includes, e.g., is at least partially formed from, a second, dissimilar metallic material, such as a copper-nickel alloy. To facilitate temperature regulation of the tank 3, the TCU 10 utilizes the thermoelectric effect, also sometimes known as the Peltier effect, wherein the dissimilar metals of the respective inner and outer surfaces 11, 12 are subjected to a controlled flow of current from the power source 13 such that one of the inner and outer surfaces 11, 12 experiences an increase in temperature, and the other of the inner and outer surfaces experiences a decrease in temperature.

In one embodiment, the outer surface 12 of the TCU 10 includes, e.g., is at least partially formed from, copper, and the inner surface includes, e.g., is at least partially formed from, copper-nickel alloy. In alternate embodiments, however, the respective inner and outer surfaces 11, 12 may include, e.g., may be at least partially formed from, any dissimilar materials capable of achieving the desired thermoelectric effect upon the flow of current to the surfaces 11, 12. It is also envisioned that the respective inner and outer surfaces 11, 12 may include combinations of materials to achieve a particular effect, e.g., a particular range of available temperature options. Dependent upon the desired rate of heating and cooling, and/or the desired temperature range, it may be desirable to vary the materials respectively included in the inner and outer surfaces 11, 12, or to utilize certain materials either exclusively, or in combination with each other.

The TCU 10 may be configured and oriented to either heat or cool the tank 3 and/or the fluid within the tank 3 via contact with the inner surface 11 of the TCU 10. To achieve the opposite effect, i.e., to change from a “cooling” mode to a “heating” mode, the flow of current to the respective inner and outer surfaces 11, 12 can simply be reversed, e.g., via manipulation of one of the toggles 17 or the power switch/button 18.

The rate at which the tank 3 may be cooled and heated, and the extent to which the tank 3 may be cooled and heated, may be adjusted by increasing or decreasing the surface area of the material in contact with the tank 3, and/or by varying the first and second metallic materials respectively included in the inner and outer surfaces 11, 12. Specifically, increasing the surface area of the material in contact with the tank 3 will increase not only the rate at which the tank 3 may be cooled and heated, but the achievable range of temperatures, while decreasing the surface area of the material in contact with the tank 3 will reduce the rate at which the tank 3 may be cooled and heated, as well as the achievable range of temperatures. Dependent upon the particular materials used in fabrication of the TCU 10, it is envisioned that the surface areas of the respective inner and outer surfaces 11, 12 may be approximately equal to each other, e.g., ±10%, that the surface area of the inner surface 11 may exceed the surface area of the outer surface 12, or that the surface area of the outer surface 12 may exceed the surface area of the inner surface 11.

By maintaining a constant resistance, voltage can be varied, e.g., via toggles 17, to adjust current flow. Alternatively, by varying resistance, current can be varied with a constant voltage. To this end, it is further envisioned that the TCU 10 may include one or more resistors, or other such control means, to facilitate control of the current from the power source 13. By varying the amount of current flowing to the TCU 10 from the power source 13, the cooling and heating effect of the TCU 10 can thus be regulated to permit more precise control over the temperature of the tank 3 and/or the fluid retained therein.

In operation, as discussed above, the TCU 10 may be utilized to adjust the temperature of the tank 3 and/or the fluid retained within the tank 3. For example, when the vaporizer 100 is exposed to higher ambient temperatures, e.g., above 80° F., the TCU 10 can be utilized to cool the tank 3 in order to inhibit the leakage of fluid that may otherwise occur. Additionally, or alternatively, the TCU 10 can be utilized to maintain the fluid within the tank 3 at a particular desired temperature. For example, fluids with certain flavor profiles may be more enjoyable at certain temperatures, which may be either higher or lower than room temperature, or the temperature of the ambient. It is also envisioned that the tank 3 may be filled with fluids having flavor profiles that vary with temperature. For example, certain fluids may have a particular flavor profile at one temperature, and another flavor profile at another temperature. To facilitate such changes in temperature of the fluid, the flow of current may be varied to alternate between “cooling” and “heating” modes, and/or the resistor may be actuated to increase or decrease the flow of current to the TCU 10, e.g., via the toggles 17.

By varying the temperature of the fluid housed within the tank 3, the viscosity of the fluid may also be influenced. For example, it has been found that the flow of fluid through the tank 3 to the atomizer 9 may be inhibited at colder temperatures. In such instances, the TCU 10 may be utilized to heat the tank 3, and thus the fluid, such that the flow of fluid is normalized.

With continued reference to FIGS. 2 and 3, the controller 16 and the thermocouples 14, 15 will be discussed. The thermocouples 14, 15 are positioned in electrical communication with the controller 16 such that temperature data collected by the thermocouples 14, 15 is delivered to the controller 16, which is in turn in electrical communication with the power source 13. The thermocouple 15 is configured, dimensioned, and adapted to collect data regarding the temperature of the tank 3, e.g., the temperature of an outer surface of the tank 3, which will typically correspond to the temperature of the fluid housed within the tank 3, and the thermocouple 14 is configured, dimensioned, and adapted to collect data regarding the temperature of the outer surface 12 of the TCU 10. It is envisioned that the controller 16 may be programmed to intermittently interrupt the flow of current to the TCU 10 via communication with the power source 13 when the temperature measured by one or more of the thermocouples 14, 15 reaches a predetermined threshold, e.g., to prevent overheating, or to maintain the temperature at the predetermined threshold value.

While in the specific design illustrated in FIGS. 2 and 3, the thermocouple 15 is shown in contact with the outer surface 12 of the tank 3 and the thermocouple 14 is shown embedded in the outer surface 12 of the TCU, the thermocouples 14, 15 and the controller 16 may be positioned in any location suitable for the intended purpose of collecting and processing temperature information communicated from the respective first and second surfaces 11, 12. As such, the locations of the thermocouples 14, 15 and/or the controller 16 may be varied without departing from the scope of the present disclosure.

In certain embodiments, it is envisioned that a desired temperature, or other such data, may be input into the controller 16, thereby providing the user with the ability to customize the temperature at which the vaporizer 100 operates independently of the ambient temperature. For example, the user may employ the toggles 17 to input a desired temperature, or temperature condition such as “cold,” “cool,” “warm,” or “hot,” which can be read from the display 19. Additional options and measurements may include a power level setting for the vaporizer 100 and the atomizer 9 (FIG. 1), a voltage setting for operation of the vaporizer 100 and the atomizer 9, remaining vapes, e.g., based upon the available amount of power in the power source 13, and color choices for the display 19. For example, temperature data collected by the thermocouples 14, 15 may be delivered to the controller 16 for processing to determine the current required to maintain a selected temperature or temperature condition.

To further regulate heat dissipation of the TCU 10, in one embodiment, it is envisioned that the TCU 10 may include a heat sink.

When operating to cool the tank 3, current is delivered from the power source 13 to the TCU 10 such that the temperature of the outer surface 12 of the TCU 10 increases, and the temperature of the inner surface 11 of the TCU 10 decreases. To inhibit any undesired contact between the user and the outer surface 12 of the TCU 10, the TCU 10 may further include a sleeve, cover, insulative member, etc., positioned about the outer surface 12 of the TCU 10.

During operation of the TCU 10, it is envisioned that the display 19 may provide the user with various types of information concerning operation of the vaporizer 100 including, but not limited to, temperature information, e.g., the temperature of the tank 3 and/or the temperature of the outer surface 12 of the TCU 10, power remaining in the power source 13, etc.

In various embodiments of the disclosure, it is envisioned that certain components and features of the TCU 10 may be eliminated, such as the toggles 17, the display 19, the thermocouples 14, 15, etc., e.g., to c. In such embodiments, however, the general principles of operation of the TCU 10 would remain otherwise unchanged. For example, it is envisioned that the TCU 10 may operate independently of any user input, other than powering the TCU 10 on and off. In such embodiments, the TCU 10 may operate in accordance with preprogrammed settings, e.g., to prevent overheating/overcooling. It is also envisioned that the TCU 10 may be configured and adapted for operation in alternate modes. For example, the TCU 10 may be programmed either to accept user input, or to operate without user input.

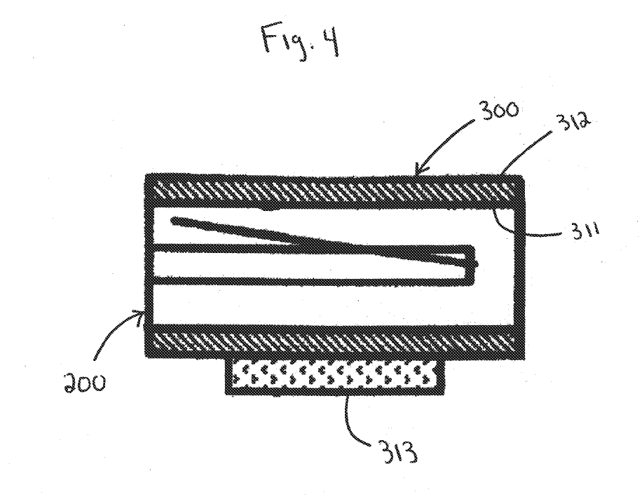

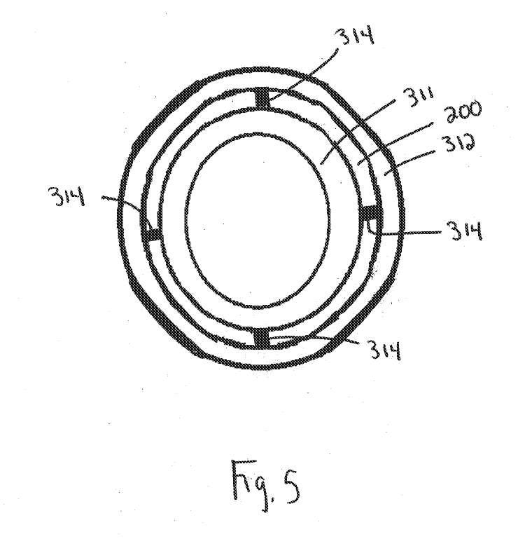

While the TCU 10 discussed above has been described as a standalone device that may be used in conjunction with the vaporizer 100 (FIG. 1), in an alternate aspect of the disclosure, seen in FIG. 4, a tank 200 is disclosed that includes an integral TCU, which is identified by the reference character 300. The tank 200 and the TCU 300 are identical to the tank 3 and the TCU 10 discussed above but for the integration of the two components, and any distinctions discussed below.

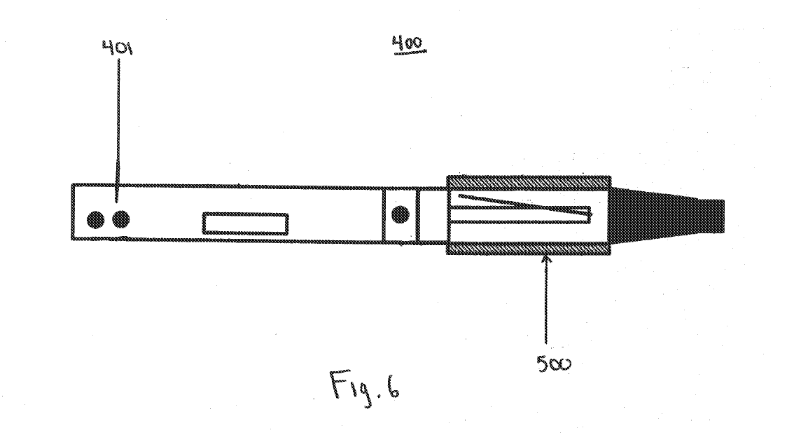

The tank 200 and the TCU 300 are integrally connected, e.g., via a suitable adhesive or a pressure-fit arrangement, or via formation from a common material, e.g., such that the tank 200 and the TCU 300 share a common wall. In one embodiment, illustrated in FIG. 4, it is envisioned that the TCU 300 may be configured and dimensioned such that the respective inner and outer surfaces 311, 312 are each be located externally of the tank 200. Specifically, the TCU 300 may be oriented such that the inner surface 311 is in contact with an outer surface of the tank 200. Alternatively, the TCU 300 may be configured and dimensioned such that the inner surface 311 is located within the tank 200, and the outer surface 312 is located externally of the tank 200, as illustrated in FIG. 5. In such embodiments, the respective inner and outer surfaces 311, 312 may be connected by one or more bridge members 314 that extend between the surfaces 311, 312.

With momentary reference to FIG. 1, it is not uncommon for the various components of the vaporizer 100 to be provided separately in the marketplace. For example, once a vaporizer 100 has initially been purchased, a user may elect to purchase an additional battery 1, tanks 3, and/or mouthpieces 5, or to refill the tank 3 with different varieties of fluid. In such instances, rather than purchasing the tank 3, the user may opt for the tank 200, and thus, the TCU 300, illustrated in FIG. 4 to provide for an increased measure of control over operation of the vaporizer 100. The tank 200 may simply be exchanged for the tank 3, and connected to the remaining portion of the vaporizer 100.

It is envisioned that the TCU 300 may include a separate power source 313, as discussed above in connection with the power source 13 illustrated in FIGS. 2 and 3. Alternatively, it is envisioned that the tank 200 may be placed into electrical communication with the power source of the vaporizer 100, i.e., the battery 1 illustrated in FIG. 1, upon connection to the vaporizer 100, as is common in the art.

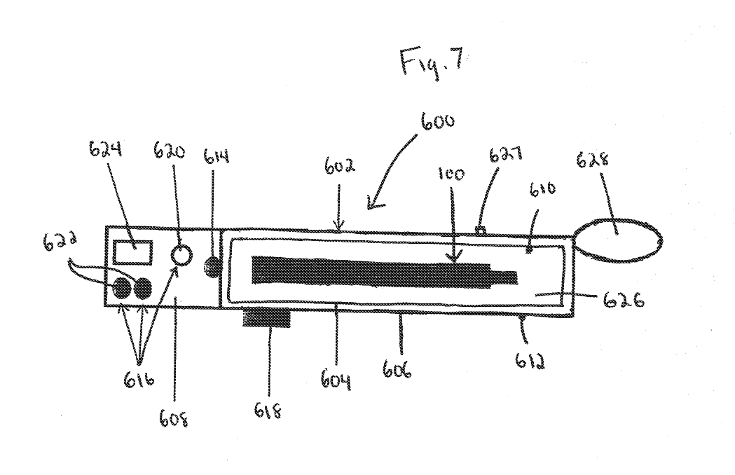

With reference now to FIG. 6, a personal vaporizer is illustrated, identified generally by the reference character 400, that includes an integral TCU 500. The personal vaporizer 400 and the TCU 500 are identical to the personal vaporizer 100 and the TCU 10 discussed above but for the integration of the TCU 500, and the distinctions highlighted below.

As discussed above in connection with FIG. 5, it is envisioned that the TCU 500 may include a separate power source. Alternatively, the TCU 500 may be in direct electrical communication with the power source of the vaporizer 400, i.e., the battery 401, thereby obviating the need for an additional power source.

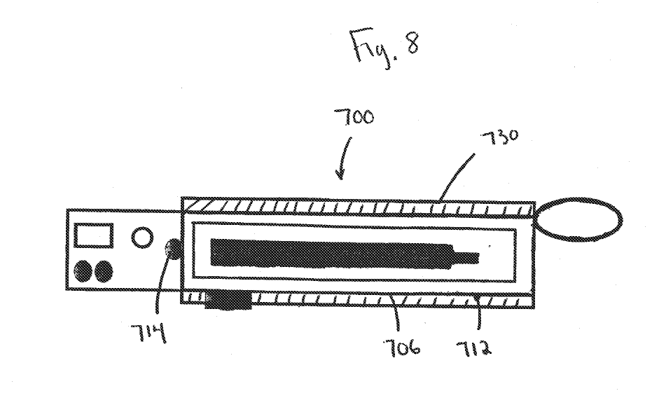

With reference now to FIG. 7, an alternate embodiment of the TCU will be discussed, which is identified generally by the reference character 600. The TCU 600 incorporates various features and components described in connection with the preceding embodiments of the disclosure. Accordingly, in the interest of brevity, where appropriate, certain information pertaining to such features and components may be omitted.

The temperature control unit 600 includes a body portion 602 with respective inner and outer surfaces 604, 606, a power source 608, e.g., a battery, in electrical communication with the respective inner and outer surfaces 604, 606, thermocouples 610, 612, a controller 614, e.g., a microchip including a processor, one or more toggles (switches) 616, e.g., a power switch/button 618, a current direction switch 620, and/or voltage controls 622, as well a display 624, e.g., an LED display.

The body portion 602 of the TCU 600 is configured and dimensioned to receive a vaporizer, such as the vaporizer 100 (FIG. 1), for example. Specifically, the body portion 602 defines an internal chamber 626 that is configured and dimensioned to accommodate insertion of the vaporizer 100, or a portion of the vaporizer 100, e.g., the tank 3 (FIG. 2), whereby the TCU 600 provides the user with a measure of control over the temperature of the vaporizer 100 and/or the fluid within the tank 3.

As discussed above in connection with the TCU 10 (FIGS. 2, 3), the inner surface 604 of the TCU 600 includes, e.g., is at least partially formed from, a first metallic material, such as copper, and the outer surface 606 of the TCU 600 includes, e.g., is at least partially formed from, a second, dissimilar metallic material, such as a copper-nickel alloy. During use of the TCU 600, the dissimilar metals of the respective inner and outer surfaces 604, 606 are subjected to a controlled flow of current from the power source 608 such that one of the surfaces 604, 606 experiences an increase in temperature, and the other of the surfaces 604, 606 experiences a decrease in temperature.

In one particular embodiment, the outer surface 606 of the TCU 600 includes, e.g., is at least partially formed from, copper, and the inner surface 604 includes, e.g., is at least partially formed from, copper-nickel alloy. In alternate embodiments, however, the respective inner and outer surfaces 604, 606 may include, e.g., may be at least partially formed from, any dissimilar materials capable of achieving the desired thermoelectric effect upon the flow of current to the surfaces 604, 606. It is also envisioned that the surfaces 604, 606 may include combinations of materials to achieve a particular effect, e.g., a particular range of available temperature options. Dependent upon the desired rate of heating and cooling, and/or the desired temperature range, it may be desirable to vary the materials respectively included in the surfaces 604, 606, or to utilize certain materials either exclusively, or in combination with each other.

The TCU 600 may be configured and oriented to either heat or cool the vaporizer 100, e.g., the fluid within the tank 3 (FIG. 2). To achieve the opposite effect, i.e., to change from a “cooling” mode to a “heating” mode, the flow of current to the respective inner and outer surfaces 604, 606 can simply be reversed, e.g., via manipulation of one of the toggles 616. In the particular embodiment illustrated in FIG. 7, for example, the TCU 600 includes a current direction switch 620 that reverses current flow to facilitate manual alternation between heating and cooling.

The rate at which the liquid within the tank 3 may be cooled and heated, and the extent to which the liquid may be cooled and heated, may be adjusted by increasing or decreasing the effective surface area of the respective inner and outer surfaces 604, 606, i.e., those portions of the surfaces 604, 606, that actually contribute to heating and/or cooling, and/or by varying the first and second metallic materials respectively included in the inner and outer surfaces 604, 606. Dependent upon the particular materials used in fabrication of the TCU 600, it is envisioned that the effective surface areas of the surfaces 604, 606 may be approximately equal to each other, e.g., ±10%, that the effective surface area of the inner surface 604 may exceed the effective surface area of the outer surface 606, or that the effective surface area of the outer surface 606 may exceed the effective surface area of the inner surface 604.

With continued reference to FIG. 7, the controller 614 and the thermocouples 610, 612 will be discussed. The thermocouples 610, 612 are positioned in electrical communication with the controller 614 such that temperature data collected by the thermocouples 610, 612 is delivered to the controller 614, which is in turn in electrical communication with the power source 608. The thermocouple 610 is configured, dimensioned, and positioned to collect data pertaining to the temperature of the fluid within the tank 3, which will correspond generally to the temperature within the internal chamber 626, and the thermocouple 612 is configured, dimensioned, and adapted to collect data regarding the temperature of the outer surface 606 of the TCU 600. It is envisioned that the controller 614 may be programmed to intermittently interrupt the flow of current via communication with the power source 608 when the temperature measured by one or more of the thermocouples 610, 612 reaches a predetermined threshold, e.g., to prevent overheating and/or overcooling, or to maintain the temperature at the predetermined threshold value.

While in the specific design illustrated in FIG. 7, the thermocouples 610, 612 are shown in contact with the surfaces 604, 606, respectively, the thermocouples 610, 612 and the controller 614 may be positioned in any location suitable for the intended purpose of collecting and processing temperature information communicated from the respective first and second surfaces 604, 606. As such, the locations of the thermocouples 610, 612 and/or the controller 614 may be varied without departing from the scope of the present disclosure. Additionally, while the TCU 600 is shown as including a pair of thermocouples, i.e., thermocouples 610, 612, in alternate embodiments of the disclosure, the number of thermocouples may be increased or decreased without departing from the scope of the present disclosure. For example, it is envisioned that the TCU 600 may include a single thermocouple only, e.g., in communication with the inner surface 604.

In certain embodiments, it is envisioned that a desired temperature, or other such data, may be input into the controller 614, thereby providing the user with the ability to customize the temperature at which the vaporizer 100 is maintained, and thus, the fluid within the tank 3, independently of the ambient temperature. For example, the user may employ the toggles 616 to input a desired temperature, or temperature condition such as “cold,” “cool,” “warm,” or “hot,” which can be read from the display 624. Additional options and measurements may include a voltage setting for operation of the TCU 600, remaining power in the power source 608, color choices for the display 624, etc.

In one embodiment, it is envisioned that the TCU 600 may include a temperature sensor 627, as illustrated in FIG. 7, in order to measure the ambient temperature, the temperature of the tank 3, etc., prior to activation of the TCU 600. In such embodiments, the temperature sensor 627 measures and relays temperature data to the controller 614 such that the controller 614 can activate the TCU 600 independently of any input from the user, e.g., upon the measurement of a predetermined threshold temperature by the temperature sensor 627. For example, when the temperature sensor measures an ambient temperature of 80° F., for example, the controller 614 can activate the TCU 600 to automatically cool the vaporizer 100, e.g., in order to prevent the leakage of fluid from the tank 3 (FIG. 2) that may otherwise occur upon exposure to such an elevated temperature. Alternatively, when the temperature sensor measures an ambient temperature of 32° F., for example, the controller 614 can activate the TCU 600 to automatically heat the vaporizer 100, e.g., in order to maintain or increase viscosity of the fluid within the tank 3 (FIG. 2).

During use of the TCU 600, the user simply positions the vaporizer 100, or alternatively, the tank 3 of the vaporizer 100 itself, within the internal chamber 626 defined by the body portion 602, and elects whether to operate in a “heating mode” or a “cooling mode,” e.g., via the toggles 616. For example, the user may elect to cool or heat the vaporizer 100 (or the tank 3) to a particular temperature. In order to ensure that the vaporizer 100 (or the tank 3) remains positioned within the TCU 600, the body portion 602 may include a lid 628 or cover that can be opened and closed. In addition to ensuring that the vaporizer 100 (or the tank 3) remains positioned within the TCU 600, the lid 628 may also operate to achieve/maintain the selected temperature, or temperature condition, by limiting exposure of the internal chamber 626 to the ambient, and thus, heat exchange, to increase efficiency of the TCU 600.

When use of the vaporizer 100 is desired, the user can simply open the lid 628, if included, and use the vaporizer 100 (or the tank 3) as normal. When operating to cool the vaporizer 100 (or the tank 3), current is delivered from the power source 608 such that the temperature of the outer surface 606 increases, and the temperature of the inner surface 604 decreases. Conversely, when operating to heat the vaporizer 100 (or the tank 3), current is delivered from the power source 608 such that the temperature of the outer surface 606 decreases, and the temperature of the inner surface 604 increases. In order to inhibit any undesired contact between the user and the outer surface 606, the TCU 600 may further include a sleeve (not shown), cover, insulative member, etc., positioned either partially or entirely about the outer surface 606.

In various embodiments of the disclosure, it is envisioned that certain components and features of the TCU 600 may be eliminated, such as the toggles 616, the display 624, the thermocouples 610, 612, etc., e.g., to reduce manufacturing costs. In such embodiments, however, the general principles of operation of the TCU 600 would remain otherwise unchanged. For example, it is envisioned that the TCU 600 may operate independently of any user input, other than powering the TCU 600 on and off. In such embodiments, the TCU 600 may operate in accordance with preprogrammed settings, e.g., to prevent overheating/overcooling upon exposure to increased or decreased ambient temperatures. It is also envisioned that the TCU 600 may be configured and adapted for operation in alternate modes. For example, the TCU 600 may be programmed either to accept user input, or to operate without user input.

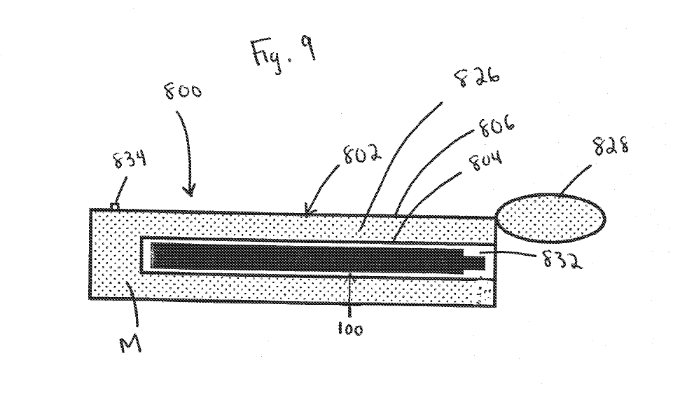

With reference now to FIG. 8, a TCU is illustrated, identified generally by the reference character 700. The TCU 700 is identical to the TCU 600 discussed above but for the distinctions highlighted below.

The TCU 700 includes a heat sink 730, which facilitates the removal of energy from the TCU 600. For example, when operating to cool the vaporizer 100 (or the tank 3), as the temperature of the outer surface 706 increases, the heat sink 730 will function to dissipate heat from the outer surface 706, e.g., such that the user can comfortably handle the TCU 600.

As illustrated in FIG. 8, it is envisioned that the TCU 700 may include a thermocouple 712 this is positioned and adapted to collect temperature data from not only outer surface 706, but from the heat sink 730, for communication to controller 714 for processing. For example, if the temperature measured by the thermocouple 712 falls outside the range of acceptable values, the controller 714 can modify current flow until the measured temperature becomes acceptable, e.g., to prevent overheating and/or overcooling.

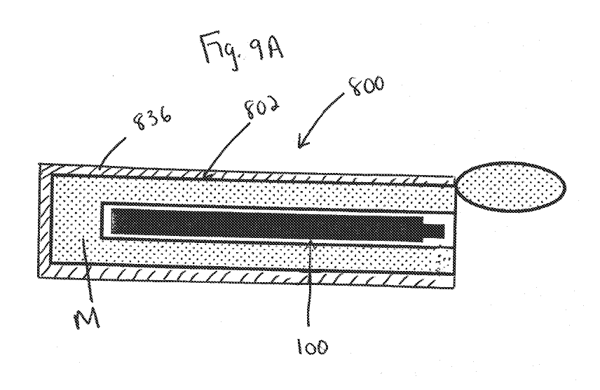

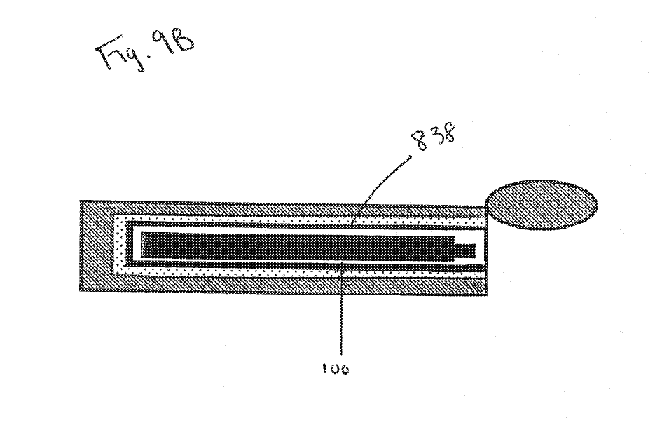

With reference now to FIG. 9, another embodiment of the presently disclosed TCU will be discussed, which is identified generally by the reference character 800.

The temperature control unit 800 includes a body portion 802 with respective inner and outer walls 804, 806 defining an internal cavity 826 therebetween that is configured, dimensioned, and adapted to retain a temperature control medium M, which may include any medium or substance capable of being heated or cooled, e.g., a thermal gel, water, ice, etc., either individually or in combination. The body portion 802 may include, e.g., be formed partially or entirely from, any suitable thermoconductive material that facilitates the transfer of thermal energy to or from the medium M, e.g., metallic materials, such as stainless steel, copper, etc., plastics, polymeric materials, glass, etc. The configuration and dimensions of the TCU 800 and the internal cavity 826 may be altered or varied to increase or decrease the volume of the medium M employed in various embodiments to increase or decrease the temporal span over which a transfer of thermal energy may take place.

The body portion 802 of the TCU 800 further defines a chamber 832 that is configured and dimensioned to receive a vaporizer, such as the vaporizer 100 illustrated in FIG. 1, for example. Specifically, the chamber 832 is configured and dimensioned to accommodate insertion of the vaporizer 100 such that the medium M retained within the internal cavity 826 is positioned about the vaporizer 100 to facilitate the transfer of thermal energy between the vaporizer 100 and the TCU 800.

In preparation to use the TCU 800 in connection with the vaporizer 100, the TCU 800 can be subjected to either heating or cooling. For example, when cooling of the vaporizer 100 is desired, the TCU 800 can be placed in a cold environment, e.g., the TCU 800 can be placed in a refrigerator, a freezer, in a vessel filled with ice water, etc., for a period of time sufficient to chill the medium M, and when heating of the vaporizer 100 is desired, the TCU 800 can be placed in a warm environment, e.g., the TCU 800 can be placed in a microwave, an oven, in a vessel filled with heated or boiling water, etc., for a period of time sufficient to heat the medium M. Consequently, it is envisioned that the materials used in construction of the TCU 800 will be capable of withstanding fluctuations in temperature without ill effect, e.g., melting. In one particular embodiment, it is contemplated that the TCU 800 will be entirely devoid of any non-removable metallic components to permit safe use of the TCU 800 with a microwave.

After the TCU 800 has been sufficiently cooled or heated, the vaporizer 100, or portion thereof, e.g., the tank 3 (FIG. 2), can simply be inserted into the chamber 832, after which, the medium M will either draw heat from the vaporizer 100 or communicate heat to the vaporizer 100 to increase or decrease the temperature of the vaporizer 100, e.g.., the temperature of the fluid retained within the tank 3, as desired.

In the embodiment of the TCU 800 illustrated in FIG. 9, the TCU 800 includes a lid 828 or cover that can be opened and closed, e.g., to facilitate positioning of the vaporizer 100 within the chamber 832 or filling of the cavity 826 with the medium M. The lid 828 may also ensure that the vaporizer 100 (or the tank 3) remains positioned within the TCU 800, and may operate to limit exposure of the chamber 832 to the ambient, and thus, heat exchange with the ambient, to increase efficiency of the TCU 800.

Additionally, or alternatively, it is envisioned that the TCU 800 may include a fill port 834, as seen in FIG. 9, in the form of a nozzle, aperture, etc. to facilitate the addition or removal of the medium M, or replacement of the medium M.

In one embodiment, illustrated in FIG. 9A, the TCU 800 may further include an insulative member 836, e.g., a sleeve, cover, etc., positioned about the body portion 802 of the TCU 800 to decrease the rate at which the medium M is heated or cooled during exposure of the TCU 800 to the ambient, and consequently, the rate at which the vaporizer 100 is heated or cooled, and thus, efficiency of the TCU 800. The insulative member 836 may be formed from any material suitable for this intended purpose, including, but not limited to, rubberized or polymeric materials.

In another embodiment, illustrated in FIG. 9B, either in addition to the insulative member 836 (FIG. 9A), or in place of the insulative member 836, the TCU 800 may further include an inner liner 838 to further facilitate heating and/or cooling of the TCU 800. It is envisioned that the liner 838 may be either removable from the body portion 802 of the TCU 800, or removable therefrom.

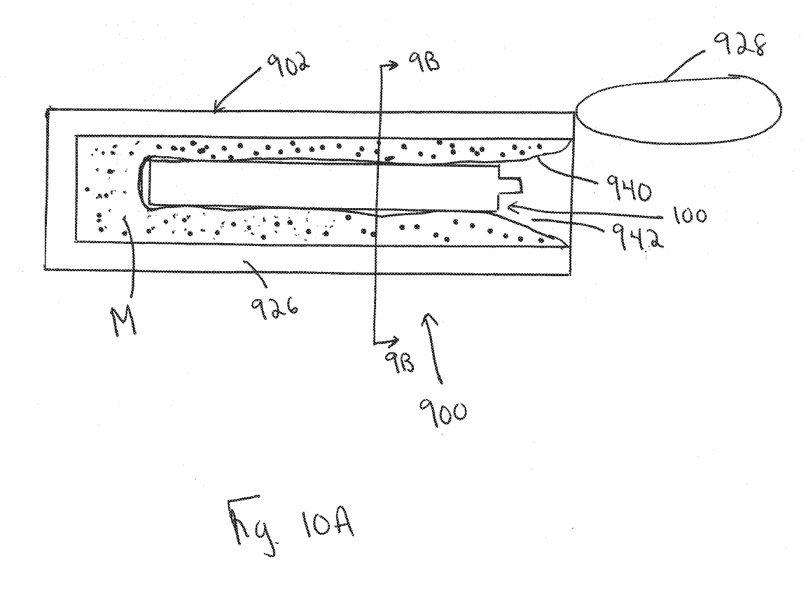

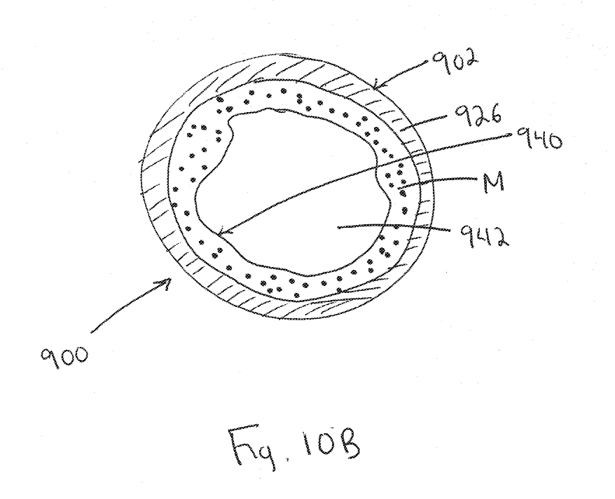

With reference now to FIGS. 10A and 10B, another embodiment of the TCU will be described, which is identified generally by the reference character 900. The TCU 900 is identical to the TCU 800 discussed above but for the distinctions highlighted below.

Rather than being retained within the internal cavity 926, as discussed above in connection with the TCU 800 (see FIG. 9), in the context of the TCU 900, the medium M is retained within an internal bladder 940 that is secured to the body portion 902. The bladder 940 may be formed from any flexible material suitable for the intended purpose of retaining the medium M, e.g., polymeric or rubberized materials, and defines a receiving area 942 that is configured and dimensioned to accommodate the vaporizer 100, or portion thereof, e.g., the tank 3 (FIG. 2). For example, in the illustrated embodiment, the bladder 940 is depicted as being cylindrical in shape. In alternative embodiments, however, the bladder 940 may assume other geometrical configurations, e.g., torroidal.

During use of the TCU 900, after the TCU 900 has been sufficiently cooled or heated, the vaporizer 100 (or the tank 3) may be inserted into the receiving area 942 for contact with the bladder 940. It is envisioned that the material of construction used in fabrication of the bladder 940 may permit deformation or deflection of the bladder 940, if necessary, to accommodate receipt of the vaporizer 100 (or the tank 3). Dependent upon the configuration and dimensions of the TCU 900, the bladder 940, and the vaporizer 100, it is envisioned that the TCU 900 may receive the vaporizer 100 (or the tank 3) such that movement of the vaporizer 100 (or the tank 3) within the TCU 900 is restricted, or prevented entirely.

Although illustrated as including a lid 928 in the embodiment shown in FIGS. 10A and 10B, in alternate embodiments of the TCU 900, the lid 928 may be eliminated.

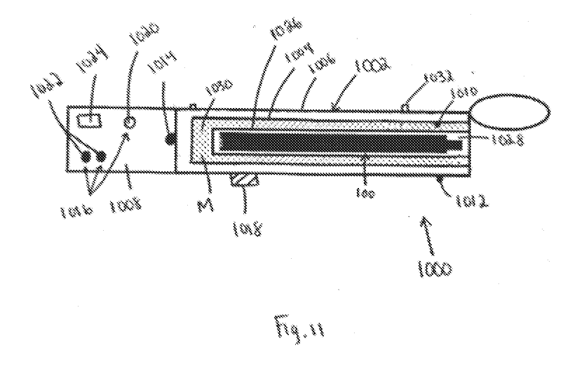

With reference now to FIG. 11, another embodiment of the TCU will be described, which is identified generally by the reference character 1000. The TCU 1000 incorporates various features and components common to the TCU 600 (FIG. 7) and the TCU 800 (FIG. 9). Accordingly, in the interest of brevity, where appropriate, certain information pertaining to such features and components may be omitted.

The temperature control unit 1000 includes a body portion 1002 with respective inner and outer surfaces 1004, 1006, a power source 1008, e.g., a battery, in electrical communication with the respective inner and outer surfaces 1004, 1006, thermocouples 1010, 1012, a controller 1014, e.g., a microchip including a processor, one or more toggles (switches) 1016, e.g., a power switch/button 1018, a current direction switch 1020, and/or voltage controls 1022, as well a display 1024, e.g., an LED display.

The body portion 1002 of the TCU 1000 includes an inner wall 1026 defining an internal chamber 1028 that is configured and dimensioned to receive a vaporizer, such as the vaporizer 100 (FIG. 1), or a portion thereof, as well as an internal cavity 1030 located between the inner surface 1004 and the inner wall 1026 that is configured, dimensioned, and adapted to retain the aforedescribed temperature control medium M. As discussed in connection with the TCUs 800 (FIGS. 9) and 900 (FIG. 10A), the body portion 1002 of the TCU 1000 is configured and dimensioned such that the medium M is positioned about the vaporizer 100. To facilitate the transfer of thermal energy, the body portion 1002 includes, e.g., is partially or entirely from, one or more thermoconductive materials, which permits thermal energy to be transferred between the inner surface 1006 and the medium M, and thus, between the medium M and the vaporizer 10 to heat or cool the vaporizer 100, e.g., the fluid retained within the tank 3 (FIG. 2).

As discussed above in connection with the TCU 600 (FIGS. 2, 3), the surfaces 1004, 1006 of the TCU 1000 include, e.g., are at least partially formed from, dissimilar metallic materials such that one of the surfaces 1004, 1006 experiences an increase in temperature upon being subjected to a controlled flow of current, and the other of the surfaces 1004, 1006 experiences a decrease in temperature. By reversing the flow of current, e.g., via manipulation of one of the toggles 1016, the TCU 1000 can alternate between “cooling” and “heating” modes. As discussed above, by increasing or decreasing the effective surface area of the surfaces 1004, 1006, and/or by varying the materials used in fabrication of the TCU 1000, the rate at which the liquid within the vaporizer 100 may be cooled and heated, and the extent to which the liquid may be cooled and heated, may be adjusted.

The thermocouples 1010, 1012 are positioned in electrical communication with the controller 1014 such that temperature data collected by the thermocouples 1010, 1012 is delivered to the controller 1014, which is in turn in electrical communication with the power source 1008, such that the controller 1014 may regulate operation of the TCU 1000. For example, the controller 1014 may be programmed to intermittently interrupt the flow of current to the surfaces 1004, 1006 when the temperature measured by one or more of the thermocouples 1010, 1012 reaches a predetermined threshold. Additionally, or alternatively, it is envisioned that a desired temperature, or other such data, may be input into the controller 1014, thereby providing the user with the ability to customize the temperature, or temperature condition, at which the vaporizer 100 is maintained.

In one embodiment, the TCU 1000 may include a temperature sensor 1032, as illustrated in FIG. 11, in order to measure the ambient temperature, the temperature of the tank 3, etc., prior to activation of the TCU 1000. The temperature data measured by the temperature sensor 1032 can be relayed to the controller 1014 such that the controller 1014 can activate the TCU 1000 to automatically cool or heat the vaporizer 100, i.e., without input from the user.

During use of the TCU 1000, the user simply positions the vaporizer 100, or alternatively, the tank 3 (FIG. 2) of the vaporizer 100 itself, within the internal chamber 1028 defined by the body portion 1002, and elects whether to operate in a “heating mode” or a “cooling mode,” e.g., via the toggles 1016. When operating to cool the vaporizer 100 (or the tank 3), current is delivered from the power source 1008 such that the temperature of the outer surface 1006 increases, and the temperature of the inner surface 1004 decreases. As the temperature of the inner surface 1004 decreases, thermal energy is transferred between the medium M and the inner surface 1004 such that the temperature of the medium M also decreases, thereby drawing heat from the vaporizer 100 to effectuate cooling. Conversely, when operating to heat the vaporizer 100 (or the tank 3), current is delivered from the power source 1008 such that the temperature of the outer surface 1006 decreases, and the temperature of the inner surface 1004 increases. As the temperature of the inner surface 1004 increases, thermal energy is transferred between the medium M and the inner surface 1004 such that the temperature of the medium M also increases, thereby communicating heat to the vaporizer 100 to effectuate heating.

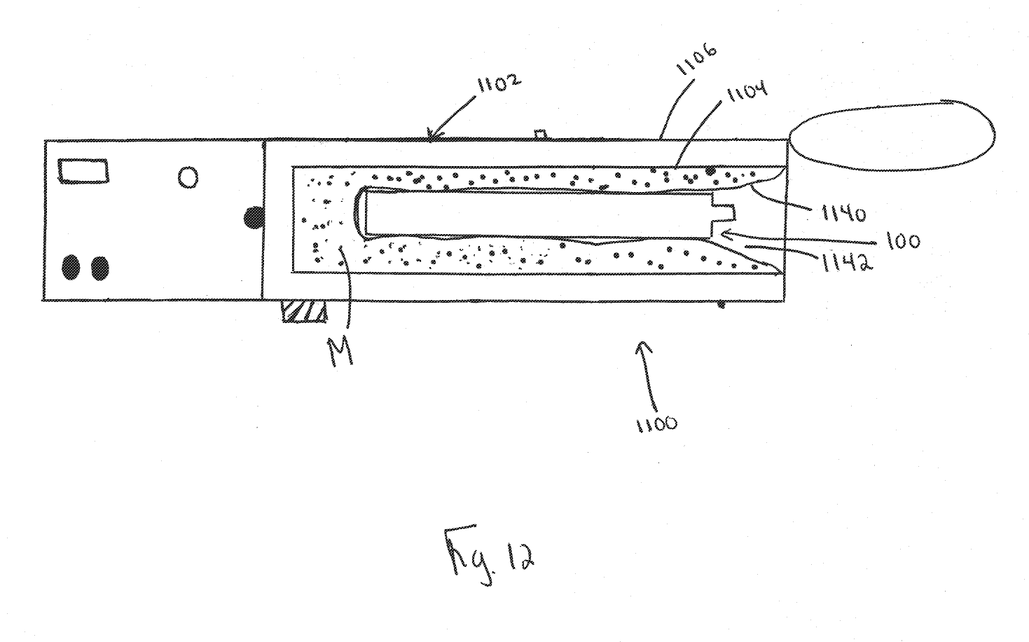

With reference now to FIG. 12, another embodiment of the TCU will be described, which is identified generally by the reference character 1100. The TCU 1100 is identical to the TCU 1000 (FIG. 11) discussed above but for the distinctions highlighted below.

Rather than being retained within the internal cavity defined by the body portion 1102 of the TCU 1100 itself, as discussed above in connection with the TCU 1000 (FIG. 11), in the context of the TCU 1100, the medium M is retained within an internal bladder 1140. The internal bladder 1140 is secured to the body portion 1102, and defines a receiving area 1142 that is configured and dimensioned to accommodate the vaporizer 100, or portion thereof, e.g., the tank 3 (FIG. 2).

During use of the TCU 1100, the vaporizer 100 (or the tank 3) is inserted into the receiving area 1142 for contact with the bladder 1140, which may deform or deflect to accommodate insertion of the vaporizer 10 (or the tank 3). It is envisioned that the TCU 1100 may be activated either prior or subsequent to insertion of the vaporizer 100 into the receiving area 1142, at which time, current is delivered to the surfaces 1104, 1106 to effectuate cooling or heating of the surfaces 1104, 1106, and consequently, the medium M and the vaporizer 100 (or the tank 3) dependent upon the mode of operation of the TCU 1100.

Persons skilled in the art will understand that the various exemplary aspects of the present disclosure described herein, and shown in the accompanying figures, constitute non-limiting examples of the present disclosure, and that additional components and features may be added to any of the embodiments discussed herein above without departing from the scope of the present disclosure.

Additionally, persons skilled in the art will understand that the elements and features shown or described in connection with one example of the present disclosure may be combined with those of another without departing from the scope of the present disclosure, and will appreciate further features and advantages of the presently disclosed subject matter based on the description provided.

What is claimed is:

1. A temperature control unit configured and dimensioned for use with a personal vaporizer, the temperature control unit comprising:
a body portion defining an internal chamber configured and dimensioned to receive at least a portion of the personal vaporizer, the body portion having an inner surface including a first metallic material, and an outer surface including a second, dissimilar metallic material; and
a power source in electrical communication with the inner and outer surfaces of the body portion such that current is flowable from the power source to the inner and outer surfaces, whereby one of the inner and outer surfaces experiences an increase in temperature, and the other of the inner and outer surfaces experiences a decrease in temperature.

2. The temperature control unit of claim 1 further including at least one thermocouple in communication with one of the inner and outer surfaces to measure the temperature thereof.

3. The temperature control unit of claim 2, wherein the at least one thermocouple includes a first thermocouple in communication with the inner surface to measure the temperature of the inner surface, and a second thermocouple in communication with the outer surface to measure the temperature of the outer surface.

4. The temperature control unit of claim 2 further including a controller in electrical communication with the at least one thermocouple such that temperature data collected by the at least one thermocouple is communicated to the controller.

5. The temperature control unit of claim 4, wherein the controller is in electrical communication with the power source such that the flow of current from the power source to the inner surface and the outer surface can be interrupted by the controller.

6. The temperature control unit of claim 5, wherein the controller is programmable to interrupt the flow of current from the power source to the inner surface and the outer surface upon the measurement of a predetermined temperature by the at least one thermocouple.

7. The temperature control unit of claim 1 further including a toggle in communication with the power source to suspend and resume the flow of current from the power source to the inner surface and the outer surface.

8. The temperature control unit of claim 1 further including at least one toggle in communication with the power source to vary current flow from the power source to the inner surface and the outer surface to thereby control the temperature of the inner and outer surfaces.

9. The temperature control unit of claim 1, wherein the inner surface defines a first surface area and the outer surface defines a second surface area.

10. The temperature control unit of claim 9, wherein the first and second surface areas are approximately equal.

11. The temperature control unit of claim 1 further including a cover movable between open and closed positions.

12. The temperature control unit of claim 1 further including an insulative member positioned at least partially about the body portion.

13. A temperature control unit configured and dimensioned for use with a personal vaporizer, the temperature control unit comprising:
a body portion defining an internal chamber configured and dimensioned to receive at least a portion of the personal vaporizer, the body portion having inner and outer walls defining a cavity therebetween configured, dimensioned, and adapted to retain a temperature control medium capable of being heated and cooled.

14. The temperature control unit of claim 13 further including the temperature control medium, the temperature control medium being a thermal gel.

15. The temperature control unit of claim 13, wherein the body portion includes a thermoconductive material to facilitate thermal energy transfer between the body portion and the temperature control medium.

16. The temperature control unit of claim 15, wherein the body portion is formed entirely of non-metallic materials.

17. The temperature control unit of claim 13 further including a cover movable between open and closed positions.

18. The temperature control unit of claim 13, wherein the body portion includes a port configured and dimensioned to facilitate filling of the cavity with the temperature control medium.

19. The temperature control unit of claim 13 further including an insulative member positioned at least partially about the body portion.

20. A temperature control unit configured and dimensioned for use with a personal vaporizer, the temperature control unit comprising:
a body portion; and
a bladder positioned within the body portion, the bladder defining a receiving area configured and dimensioned to receive at least a portion of the personal vaporizer, the bladder being configured, dimensioned, and adapted to retain a temperature control medium capable of being heated and cooled.
